(19) United States
(12) Patent Application Publication
(10) Pub. No.: US 2014/0295095 A1
(43) Pub. Date: Oct. 2, 2014

(54) In-Line Powder Coating of Non-Conductive Profiles Produced in a Continuous Forming Process such as Pultrusion and Extrusion

(71) Applicants: Robert Langlois, Grand Valley (CA); Jeffrey Sugar, Toronto (CA); Gary Sugar, Toronto (CA)

(72) Inventors: Robert Langlois, Grand Valley (CA); Jeffrey Sugar, Toronto (CA); Gary Sugar, Toronto (CA)

(21) Appl. No.: 13/855,530

(22) Filed: Apr. 2, 2013

(51) Int. Cl. B05D 1/12; B05D 1/24; B05D 1/38; B05C 5/02; B05D 3/02; B05D 3/06; B05D 3/04; B05C 9/14; B05D 1/00; B05C 19/04

(52) U.S. Cl. CPC B05D 1/12; B05D 1/007; B05D 1/24; B05D 1/38; B05C 19/04; B05D 3/0227; B05D 3/0236; B05D 3/0263; B05D 3/0272; B05D 3/029; B05D 3/063; B05D 3/067; B05D 3/0426; B05D 3/048; B05C 9/14; B05C 5/0245
USPC 427/482; 427/180; 427/185; 427/203; 427/545; 427/557; 427/558; 118/308; 118/629; 118/642; 118/641; 118/666; 118/695; 118/68

(57) ABSTRACT

A method and apparatus for the continuous powder coating of a non-conductive profile produced in a continuous forming process, such as pultrusion or extrusion, such that the profile is powder coated while on the profile forming machine and before the subject segment of the continuous profile is severed from the continuous profile on the forming machine (i.e. in-line).

### CROSS-REFERENCE TO RELATED APPLICATIONS

This application claims priority from provisional patent application 61/620,463 filed Apr. 5, 2012, incorporated herein by reference.

### BACKGROUND OF THE INVENTION

1. Field of the Invention

The present invention relates generally to the powder coating of a non-conductive profile, and more particularly to the method and apparatus for the continuous powder coating of a non-conductive profile produced in a continuous forming process, such as pultrusion or extrusion, such that the profile is powder coated in-line while on the profile forming machine and before the subject segment of the continuous profile is severed from the end of the continuous profile on the forming machine.

Many pultrusions, extrusions, and other continuously formed profiles are painted for esthetic reasons or for functional reasons including to prevent degradation of the profiles upon exposure to ultraviolet light or chemicals.

The current art for painting profiles uses solvent-based, liquid paint. To date, liquid painting is the only process used to coat fiberglass and other non-conductive pultruded profiles.

With liquid paint, solvents contained in the liquid paint are released into the air when the coating is cured. Frequently these solvents contain volatile organic compounds (VOCs) or hazardous air pollution substances (HAPS), and accordingly use of liquid paint frequently requires expensive abatement equipment to handle the VOCs and HAPS, and governmental regulation and reporting is involved. In addition, use of flammable paints requires special handling and storage procedures in the painting facility to minimize potential heath and fire hazards.

The current art is also to paint the profiles in a discreet painting operation that is separated in location and time from formation of the profile, i. e. “offline”.

2. Description of Prior Art

U.S. Pat. No. 6,165,565 issued in December 2000 to Schelhorn discloses a method for the corona treating of thermosets, whereby the corona treating allows for liquid painting to be performed in-line with the pultrusion process. Schelhorn prescribes a two-part, liquid acrylic-modified urethane which can be diluted with a solvent. The Schelhorn invention cannot be used as an in-line process in a pultrusion machine because: 1) there is no known way to corona pre-treat liquid paint and cure the coating within the confines and normal length of a pultrusion machine, and 2) corona treatment performed immediately adjacent to the application of flammable, solvent-based liquid paint could result in a fire or explosion. Unlike the Schelhorn process, the present invention does not require the surface of the profile to be treated prior to the application of paint. The present invention provides for the application of powder paint to the profile whereas the Schelhorn invention is concerned only with the application of a liquid paint. In addition, with the present invention, two or more coats of powder paint can be simultaneously or sequentially applied onto the profile after the profile is formed and while it is still on the forming machine, whereas not even a single liquid coating can be applied in this way using the Schelhorn invention.

U.S. Pat. No. 5,618,589 issued in April 1997 to McFarland discloses a method and apparatus for powder coating elongated members. This process might be used to paint such things as a fiberglass window lineal directly on a pultrusion line. McFarland states that his process requires the incorporation of a “conductive surfacing mat or veil” and additionally, that the profile be grounded in order to attract the powder to the conductive profile. The McFarland process' focus is mainly on the pultrusion process and not the painting process as additions or modifications must be made to the pultruded profile to facilitate painting of the profile using conventional, electrostatic powder coating. The present invention, however, can be used to apply a powder coating onto a conventional, unmodified, non-conductive profile and does not require that the part incorporate a conductive surface mat or veil or that the part be grounded. As the present invention focuses exclusively on painting rather than pultrusion, there is little if any similarity between the two inventions.

McFarland states that his process incorporates and requires the use of a high-voltage Corona pre-treatment system to provide adhesion of the paint to the profile. This is a costly process involving a sophisticated, high volume automated production system and it presents challenges for complex shapes. The present invention does not require the use of pre-treatment using a Corona System or any pre-treatment of the surface of the part to achieve adhesion, and it allows complex shapes to be effectively coated.

McFarland states that the temperature of the elongated member must be above the cure temperature of the powder prior to the elongated member entering the booth, whereas the present invention anticipates and provides for a part entering the powder booth to have a substantially lower temperature than the cure temperature of the powder.

McFarland states that powder is applied with a standard triboelectric or corona powder coating gun. However, pultrusions are produced at relatively slow line speeds and at these speeds the powder coating guns that McFarland prescribes would likely deposit far too much powder onto the profile. The present invention will achieve the desired film build at slow line speeds by having the powder coating gun(s) pulse on an off in the delivery of powder to adjust to the line speed of the pultrusion, by having the powder coating gun(s) oscillate, or by having them reciprocate, i.e. having the guns apply paint along a section of the profile while moving along a length of the profile and then returning to their starting position before repeating the painting cycle.

McFarland states that the elongated member will receive an electrostatic charge prior to entering the booth, whereas the present invention does not require the part to be charged or grounded.

McFarland states that air flows through the interior of the booth are in a downward direction; however, with this system it may not be possible to produce a uniform coating over the entire 360 degree circumference of a profile or to prevent the build-up of powder on the inside surfaces of the powder booth or the clogging of powder filters. The present invention allows for minimal air movement in the booth, or the movement of air in more than one direction to facilitate powder to be distributed uniformly over all surfaces of the profile or only onto specific areas, and to reduce powder build-up within the booth and the clogging of powder filters.

McFarland states that parts must be cooled upon exiting the convection oven to prevent marring of the surface that is gripped by the pullers and he proposes the use of a water fall and a final air knife to blow off residual water. The present invention will allow the painted profile to cool naturally in the ambient air, or optionally will utilize a mist of cooling water or a stream of air or other gas for this purpose, and the associated energy inputs, operating cost and equipment cost will be considerably lower than those associated with the McFarland system.

U.S. Patent Application 201237690 filed in September 2012 by Stay describes a process for electrostatically painting a fiberglass profile which process includes and requires the use of a conductive primer of “at least one halogen, halogen salt, halogen complex or mixture thereof” and that the powder coating be applied over the primer when the primer is wet. There are a number of issues with applying a powder coating over a water-based, wet primer arising from the fact that dry powder paints do not react well with humidity, let alone water. When a powder is applied over a water-based, wet primer, outgassing from the primer produces blisters and an uneven surface that is not aesthetically pleasing or acceptable. The present invention provides for powder to be applied directly onto the surface of the profile and will produce a class “A” surface finish. This process will be lower cost than a process that requires the use of a wet primer.

U.S. Patent Application 20060045980 filed in March 2006 by Johnson discloses a method and apparatus for applying thermoset paint onto a lineal product using a die to distribute the paint. There are serious issues associated with this process: 1) The process is expensive as it requires that an additional, duplicate die be made for each profile that is to be painted; 2) distributing paint uniformly over all surfaces of the profile would be next to impossible; 3) the film build and associated paint cost would necessarily be very high; and 4) it may be difficult to produce a quality finish. The present invention is different from that of Johnson in that, in the preferred embodiment, one or more electrostatic paint guns together with the heat of the lineal profile are used to apply and adhere the powder coating onto the lineal profile.

### BRIEF SUMMARY OF THE INVENTION

The present invention provides an apparatus and process for one or more of a thermoset, thermoplastic, thermoplastic elastomer, or other type of powder to be continuously applied onto a non-conductive profile produced in a continuous forming process such as pultrusion or extrusion, such that the profile is powder coated while on the profile forming machine and before the subject segment of the continuous profile is severed from the end of the continuous profile on the forming machine (i.e. in-line).

The apparatus and process may be used to coat non-conductive profiles formed from a range of materials, e.g. fiberglass, vinyl, cement, wood composite, etc. and may also be used in conjunction with or as part of a process or equipment whereby a continuous non-conductive profile is created using a method other than pultrusion or extrusion. An example of such a process is the production of fiberglass or carbon-reinforced sheet produced in a continuous, roll-forming process and where the coated sheet is accumulated on a spool or cut into panels.

A unique feature of the present invention is the ability to continuously powder coat a continuously-formed non-conductive profile without corona, conductive, or other pre-treatment, with associated reduced facility, handling and processing costs.

A further unique feature of the present invention is the ability to continuously powder coat a continuously-formed profile in-line on the profile forming machine, i.e. before the length of formed profile is severed from the end of the continuous profile, with associated reduced facility, handling and processing costs.

A further unique feature of the present invention is the ability to sequentially apply one or more layers of powder to the profile in-line on the forming machine, where the powder applied to form each additional layer is different from that of the previous layer. For example, a base coat and top coat can be applied, one immediately after the other, and both can be cured together.

The present invention releases little if any VOCs or HAPS, whereas currently-utilized liquid paint technologies frequently release significant quantities of these highly undesirable emissions.

The present invention provides significant advantages versus current liquid painting practices, including: elimination of VOCs and HAPs from the process, eliminated or reduced compliance reporting requirement, less stringent handling and storage requirements, lower material usage, significantly reduced labour costs, higher product throughput/output, reduced profile handling, smaller manufacturing footprint (as off-line paint areas and work-in-process staging areas are eliminated) and the ability to market process and products as being environmentally-friendly or “green”.

The present invention provides powder painting to be performed in-line and concurrent with the profile forming process in a single, integrated machine. In the case of a pultrusion, the apparatus will be located and the process will be performed at some point after the die and before the cut-off saw.

The present invention provides the ability to apply all types of powder paint technologies. This includes but is not limited to “standard” and “low-cure” powder technologies, with a “standard” powder technology defined as a process employing a curing temperature of 325 degrees F. and higher, and a “low cure” technology defined as a process employing a curing temperature of less than 325 degrees F. The powder paint resins that may be utilized with the invention are, but are not limited to, Polyesters, Acrylics, Polyurethanes, Epoxies and Hybrids. Paint finishes that may be produced using the process and apparatus include (but are not limited to) textures, tints, clear coats, pearlescents, metallics, and solid colors.

The present invention provides a wide range of finish options (e.g. smooth, textured, and non-slip coatings) to be used to coat the surfaces of a profile, and provides such finish options more economically than can be produced by liquid painting.

The present invention provides for a powder coating with a highly reproducible finish that will meet both automotive and architectural performance and aesthetic specifications.

The present invention provides for the application of powder onto all external surfaces of the profile, or alternatively onto only a portion of the profile's external surfaces, allowing profiles to be painted uniformly, or else unevenly if so desired. The process has been developed to accommodate any line speed, with a typical pultrusion line speed being between 0.5 and 4 linear feet per minute.

The apparatus may also include a powder reclaim device or system for the collection and reuse of powder overspray, or may allow powders to be sprayed to waste with no reclaim.

The apparatus is designed to be operated either manually or automatically and may incorporate programmable logic control systems (PLC) compatible with (but not limited to) controls and control systems manufactured by Allan Bradley, Siemens and Omron. The PLC control systems of the apparatus are designed to be interlinked with the PLC control systems of the forming machine such that all components of the combined forming/painting system are fully integrated for effective and efficient operation (e.g. shut down of pultrusion process will shut down the painting/curing process and vice versa).

### BRIEF DESCRIPTION OF THE DRAWING

FIG. 1 illustrates in schematic form an example embodiment of the present invention where the powder coating method and apparatus is applied after the die and before the puller in connection with a pultruder.

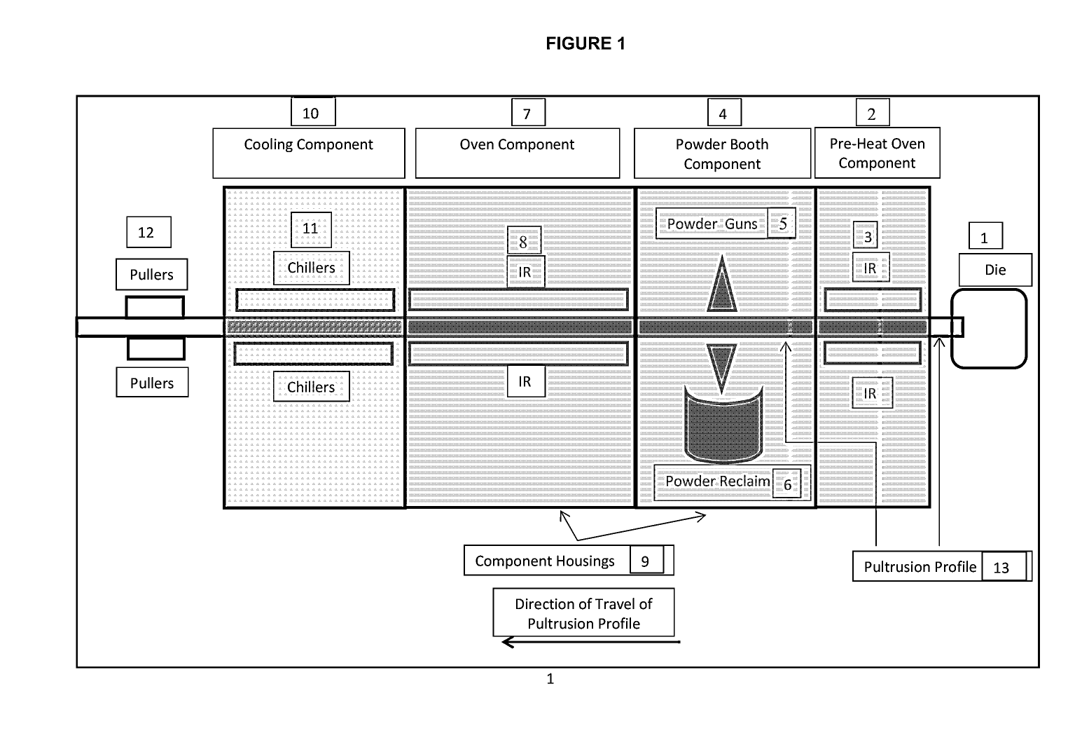

### DETAILED DESCRIPTION OF THE INVENTION

While the present disclosure may be susceptible to embodiment in different forms, there is shown in the drawing, and described herein in detail, an embodiment with the understanding that the present description is to be considered an exemplification of the principles of the disclosure and is not intended to limit the disclosure to the details of construction and the arrangements of components set forth in the following description or illustrated in the drawing. It is to be understood that other embodiments may be utilized and structural changes may be made without departing from the scope of the present invention.

The drawing illustrates, as an exemplification only, an apparatus and process for the application of powder to fiberglass profiles in-line with and integrated with the pultrusion forming process.

The pullers [12] on the pultruder pull the profile [13] with sufficient force so as to move the formed profile through/from the die [1].

The preferred embodiment incorporates the powder coating apparatus installed between the die [1] and pullers [12]. In an alternative embodiment, the powder coating apparatus can be installed after the pullers [12] and before the pultrusion profile is cut off from the end of the continuously formed profile.

The profile [13] exits the die [1] at an elevated temperature over ambient. In the preferred embodiment, the temperature of the profile exiting the die [1] will be sufficient so as to allow the powder applied in the powder booth component [4] to gel on contact with the heated profile such that it adheres, in which case the powder booth component [4] would follow immediately after the die [1] on the pultrusion machine.

Optionally, a pre-heat oven component [2] may be provided after the die [1] and before the powder booth component [4] to raise the surface temperature of the profile before the powder is applied such that the powder will adhere when it is applied. In the preferred embodiment, heat is supplied in the preheat oven component [2] by one or more infra-red (IR) heating units [3]. However, heat may be supplied by one or more of infra-red, near infra-red, or another heating technology (e.g. convection, resistive electric, ultra-violet, microwave, radio-frequency, etc.) or combination of heating technologies, at an energy level and for the duration required for the powder to adhere.

In the preferred embodiment, the powder booth component [4] will incorporate one or more corona-type powder guns [5] to distribute powder over the surface of the profile; however triboelectric or other type of guns may be used (provided the gun delivery rate is appropriate for and can be matched to the system line speed). The number of powder coating guns to be used and the positioning of the guns will depend on the area and shape of the profile to be coated, as well as the pultrusion line speed and other factors. In the preferred embodiment, powder will be applied using one or more of stationary, automatic, or PLC-controlled powder guns [5]; however the powder guns may be operated manually. The powder guns need not be stationary, but may oscillate or reciprocate along the length of the profile, or be directed by robotic applicators.

Alternatively or in addition, the powder booth component equipment will have the ability to cause the powder delivery to pulse on and off, with the timing and duration of the “on” and “off” intervals being adjustable from 0 to 5 seconds each. This feature will accommodate a relatively slow line speed (which is a feature of the pultrusion process), by enabling a suitable amount of powder to be consistently applied over the surface of the profile along its entire length. These oscillating, reciprocating, and pulsing systems are designed to overcome the limitations of traditional powder coating gun application methods (e.g. flow control and fluidization), which at slow line speeds are unable to provide a continuous flow of powder from the gun tip so as to produce a suitable film build on the surface of the profile. In another embodiment, powder can be delivered to the profile using a fluidized bed.

Powder may be “sprayed to waste”, or alternatively, overspray may be collected, sieved and re-introduced to the virgin powder material using a traditional reclaim method and technology [6].

In consideration that the profile is to be coated is at an elevated temperature over ambient, the temperature and humidity inside the powder booth component [4] may be controlled so as to prevent spider webbing of the powder film and the subsequent clogging of the collectors with super-heated powder. If the average air temperature inside the powder booth component cannot be maintained at a suitable level, typically below 80 degrees F., by ventilating with room-temperature air, the ventilation air may be pre-cooled (e.g. using an HVAC system).

The powder booth component housing's venting system will control powder movement within the powder booth component [4], (anticipating a possible “venturi effect” whereby air heated by the profile causes an undesirable movement of powder within the booth) and the escape of powder from the booth, and may be integrated with the powder reclaim system [6].

Exiting the powder booth component [4], in the preferred embodiment infra-red heating units [8] in the oven component [7] heat the surface of the profile to a temperature sufficient to cause a melting of the powder film and its curing (cross-linking of its chemical components). Heat may be supplied by one or more of infra-red, near infra-red, or another heating technology (e.g. resistive electric, ultra-violet, microwave, radio-frequency) or combination of heating technologies, at an energy level and for the duration required for the powder coating to become fully cured.

Ideally, the heating system in the oven component [7] and in the optional pre-heat oven component [2] will be of closed loop design, whereby the heating units incorporate one or more thermostats operated by PLC controllers so as to ensure a continuous, even temperature.

Exiting the oven component [7], the powder painted profile can be allowed to cool naturally in the ambient air until the profile can be handled without marring its painted surface.

Optionally, a cooling component [10] may be provided after the oven component [7] where the powder painted surface of the profile is cooled by one or more chillers [11] to a temperature of typically less than 200 degrees F., enabling the profile to be pulled by the pullers [12] without causing the freshly painted powder coating to become damaged. The preferred method for cooling the coated profile is for the chillers [11] to direct cool water mist over the profile's surface, but an inert gas, chilled air, or some other method may be used to provide cooling.

Each component housing [9] is designed to open along the length of its horizontal axis, with the top portion of the housing opening upwards and the bottom portion opening downwards, so as to provide access to the interior of the housing and so as to allow the apparatus and each component thereof to be moved while a profile remains in place on the forming machine.

Each of the apparatus components may be physically located directly next to its neighboring component on the apparatus, or the components may be spaced apart on the apparatus to allow for ventilation or compliance with governmental regulation.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected.

For example, although illustrated embodiments have been described in connection with the powder coating of a fiberglass pultrusion, it should be appreciated that the invention embodiments may be used in connection with disposition of various materials on different types of forming machines. Therefore, the illustrated embodiments may be utilized for a variety of applications as understood by one of ordinary skill in the art.

We claim:

1) A method for the continuous powder coating of a non-conductive profile produced in a continuous forming process, such as pultrusion or extrusion, such that the profile is powder coated in-line while on the profile forming machine and before the subject segment of the continuous profile is severed from the end of the continuous profile on the forming machine, comprising the following activities in the sequence set forth:
a) applying powder paint onto the hot surface of the profile; and,
b) heating the profile to cure the applied powder coating.

2) The method in claim 1) where the powder is applied to the profile using at least one member selected from the group consisting of an electrostatic paint gun, a non-electrostatic paint gun, and a fluidized bed.

3) The method in claim 1) where the powder is applied to the profile in a pulsed on/off sequence, with the timing and duration of the “on” and “off” components being adjustable from 0 to 5 seconds each.

4) The method in claim 1) where the powder is applied to the profile by one or more moving paint guns.

5) The method in claim 1) which includes the sequential application of one or more additional layers of powder to the profile, in-line while the profile is still hot, where the type of powder applied to form each additional layer is different from that of the previous layer.

6) The method in claim 1) where heating to cure the powder coated profile is provided by at least one heat source being a member selected from the group consisting of infra-red, near infra-red, resistive electric, ultra-violet, microwave, and radio-frequency.

7) The method in claim 6) where the heating to cure the powder coated profile is controlled by one or more closed-loop feedback systems.

8) The method in claim 1) further comprising heating the surface of the profile prior to the application of powder, i.e. pre-heating.

9) The method in claim 8) where the heating is provided by one or more heat source, each of which being a member selected from the group consisting of infrared, near infra-red, convection, resistive electric, ultra-violet, microwave, and radio-frequency.

10) The method in claim 8) where the heating is controlled using one or more closed-loop feedback systems.

11) The method in claim 1) further comprising cooling the hot powder coated and cured profile to allow it to be more easily handled without affecting the quality of the painted surface.

12) The method in claim 11) where the cooling is achieved by applying to the painted surface at least one member selected from the group consisting of a spray of water, a jet of air, and a jet of an inert gas.

13) An apparatus for the continuous powder coating of a non-conductive profile produced in a continuous forming process, such as pultrusion or extrusion, such that the profile is powder coated in-line while on the profile forming machine and before the subject segment of the continuous profile is severed from the end of the continuous profile on the forming machine, comprising the following components in the following order along the apparatus:
a) a powder booth component, comprising one or more powder application devices, for applying powder onto the profile; and,
b) an oven component, comprising one or more heating devices, for curing the applied powder.

14) The apparatus in claim 13) where each powder application device is a member selected from the group consisting of an electrostatic paint gun, a non-electrostatic paint gun, and a fluidized bed.

15) The apparatus in claim 13) where one or more of the powder application devices moves during the powder application process.

16) The apparatus in claim 13) where each heating device is a member selected from the group consisting of infra-red, near infra-red, resistive electric, ultra-violet, microwave, and radio-frequency.

17) The apparatus in claim 13) where one or more of the heating devices is controlled using a closed-loop feedback system.

18) The apparatus in claim 13) further comprising a pre-heat oven component, located before the powder booth component, for heating the profile prior to the application of powder.

19) The apparatus in claim 18) where such preheat oven component comprises one or more heating devices, each of which heating devices being a member selected from the group consisting of infra-red, near infra-red, convection, resistive electric, ultra-violet, microwave, and radio-frequency.

20) The apparatus in claim 18) where one or more of the heating devices is controlled using a closed-loop feedback system.

21) The apparatus in claim 13) further comprising one or more component housings where one or more of the said component housings can be opened into two parts along the length of its horizontal axis.

22) The apparatus in claim 18) further comprising a component housing which component housing can be opened into two parts along the length of its horizontal axis.

23) The apparatus in claim 13) which incorporates one or more programmable logic control systems.

24) The apparatus in claim 23) where one or more of the said programmable logic control systems of the apparatus are inter-linked with the controls of the forming machine such that the apparatus and forming machine operate effectively in unison as a single production system.

25) The apparatus in claim 13) further comprising a cooling component, comprising one or more cooling devices, for cooling the profile after the applied powder has been cured.

26) The apparatus in claim 25) where each cooling device cools by applying to the profile surface at least one member selected from the group consisting of a spray of water, a jet of air, and a jet of an inert gas.
